(19) United States
(12) Patent Application Publication
(10) Pub. No.: US 2002/0096857 A1
(43) Pub. Date: Jul. 25, 2002

(54) Bicycle trailer for a baby stroller frame with a seat

(76) Inventors: Martin Valdez, Wapato, WA (US); David A. Black, Montesano, WA (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 09/765,970

(22) Filed: Jan. 19, 2001

(51) Int. Cl. B62H 1/00; B62J 1/00

(52) U.S. Cl. 280/293; 280/504

(57) ABSTRACT

A trailer with a protective enclosure, or roll cage, for a baby stroller frame with a seat. The trailer includes left and right wheels, a trailer frame, and a towing arm for connecting the trailer to a bicycle. The trailer frame has a bottom frame, front frame, and rear frame with each frame having a plurality of frame members that form a protective roll cage for a stroller frame mounted in the trailer frame. A stroller frame can be inserted into the trailer frame, without being modified or adapted, and secured within the trailer frame for towing.

### BACKGROUND OF THE INVENTION

As the public has become more health conscious in recent years, physical activity and exercise have steadily increased in popularity. One of the more popular forms of exercise is bicycling, partially because it is an activity that families can enjoy together. When families include infants, it is sometimes desired to bring infants along, and bicycle trailers have made this possible to some extent.

Many families with infants have all-terrain strollers and assemblies are available to convert such strollers into bicycle trailers. Such conversion assemblies may help lower the cost of purchasing a trailer that would otherwise have redundant parts if purchased as stand alone devices. However, the conversion assemblies are difficult to use and must be assembled each time to adapt the assemblies to the stroller.

Stand alone bicycle trailers are an alternative to conversion assemblies but may be more expensive. Furthermore, when it is desired to have an outing involving both walk and ride with an infant, it may be necessary to transport both the stand alone bicycle trailer as well as the stroller, which requires more space than transporting a conversion assembly.

The present invention provides a simple to use trailer, with reduced numbers of redundant parts, and without sacrificing stability and protection.

### SUMMARY OF THE INVENTION

The present invention resides in a bicycle trailer for a baby stroller frame with a seat. The trailer has left and right wheels, a trailer frame, and a towing arm. A baby stroller can be mounted within the trailer by removing the wheels of the baby stroller and placing the stroller frame with the seat in the trailer and locking the stroller frame in place with locking mechanisms or latches.

The trailer frame has a bottom frame comprising left and right bottom frame tubes, a tubular rear axle, a latch support tube, and a tubular cross bar. The bottom frame tubes have left and right laterally extending frontal section tubes with latch assemblies. The frontal sections are aligned along a lateral axis at the forward end of the trailer. The latch assemblies are connected to the frontal sections for selectively locking forward end portions of parallel base frame tubes of the stroller to the trailer frame. The latch assemblies each comprise two adjacent retainer pieces with a latch pivotally disposed between the retainer pieces.

The tubular rear axle extends laterally across the bottom frame tubes with a downward bend midway between the ends of the axle, such that the end portions of the axle slope inwardly downward. The end portions are fixedly connected to the left and right bottom frame tubes, and the left and right wheels are rotatably and removably mounted on the left and right end portions of the tubular rear axle. The wheels are mounted in tilted configuration, such that bottom portions of each wheel are disposed laterally outward of the corresponding top portions.

The latch support tube extends laterally across the bottom frame tubes. Two latch assemblies are connected to the latch support tube for locking a rear axle of the stroller frame to the trailer frame.

The tubular cross bar also extends laterally across the bottom frame tubes. The trailer frame also comprises left and right parallel front frame tubes which are pivotally connected to the corresponding left and right frontal section tubes at the bottom ends thereof. The front frame tubes each extend upward from the frontal sections of the bottom frame tubes and curve rearward. In addition, there is a tubular hitch bar extending between the left and right parallel front frame tubes.

The trailer frame also comprises left and right upright rear frame tubes that are each pivotally connected to the left and right bottom frame tubes at lower ends thereof. There is a horizontal frame tube with left and right ends, which are integrally formed with the upper end portions of the left and right upright frame tubes. The horizontal frame tube is releasably connected to the upper end portions of the left and right front frame tubes.

The trailer frame also has left and right support tubes. Each of these tubes is pivotally connected to the left and right bottom frame tubes at one end and releasably connected to the left and right upright rear frame tubes at another.

The releasable connections between the tops of the parallel front frame tubes and the horizontal frame tube, and between the support tubes and the upright rear frame tubes, can be released so that the front frame tubes, support tubes, and upright rear frame tubes can all be folded downward by pivoting about the pivoting connections thereof.

The tow arm comprises a cylindrical tongue with an interior cylindrical chamber. There is also a cylindrical elastic strip inserted longitudinally within the chamber of the tongue through an opening at a forward end of the tongue. The strip is fixedly attached to a wall of the interior chamber of the tongue.

A solid cylindrical sleeve is aligned coaxially with the tongue, disposed proximate a forward end portion of the tongue. The cylindrical sleeve is sized to fit coaxially within the tongue with at least a portion of sleeve extending beyond the tongue. A forward end portion of the elastic strip is fixedly attached to the sleeve.

A hitch assembly is provided with a rearward arm and a forward arm. The arms are pivotally connected to one another by a removable pin, with the rearward arm fixedly attached to the cylindrical sleeve. A hitch, configured to be removably and securely connected to a bicycle seat bar, is fixedly attached to the forward arm.

### BRIEF DESCRIPTION OF THE DRAWINGS

FIG. 1 is an isometric view of the trailer attached to a bicycle seat bar, and a stroller with a seat and canopy inserted and secured within the trailer for towing.

FIG. 2 is an isometric view of the trailer without showing the bicycle to which the trailer would be attached when operated and without showing the stroller.

FIG. 3 is an isometric view of a typical stroller in unmodified form, that can be inserted and secured within the trailer for towing after the wheels are removed, showing the seat of the stroller and only the foldable canopy support bar.

FIG. 4 is an isometric view of the stroller of FIG. 3 without showing the seat, but showing the canopy bar for the supporting the canopy which can be pivoted to a folded position against the stroller upper frame or removed so as to not obstruct the seat.

FIG. 5 is an isometric view of the trailer frame with the wheels and tow arm removed.

FIG. 5A is an enlarged, isometric view of one of the axle latch assemblies oriented in the same position as shown in FIG. 5.

FIG. 5B is a side elevational view of the axle latch assembly of FIG. 5A.

FIG. 5C is a side elevational, cross-sectional view of the axle latch assembly of FIG. 5A, with the latch assembly in a locked position.

FIG. 5D is a side elevational, cross-sectional view of the axle latch assembly of FIG. 5A, with the latch assembly in an unlocked or released position.

FIG. 6 is a rear elevational view of the trailer frame without the baby stroller frame inserted in the trailer.

FIG. 7 is an isometric exploded view of FIG. 1 of the trailer and the stroller frame without the seat or canopy shown.

FIG. 8 is an isometric view of the trailer of FIG. 1 with a stroller frame inserted and locked in the trailer frame for operation, without the tongue being shown.

FIG. 9 is a rear elevational view of the trailer with the wheels removed and the stroller frame inserted and locked within the trailer frame, without a seat or canopy of the stroller being shown.

FIG. 10 is a side elevational view of the trailer frame showing the support tubes pivoted downward and the direction of the pivot.

FIG. 11 is a side elevational view of the trailer frame showing the front frame tubes pivoted downward and the direction of the pivot.

FIG. 12A is a side elevational view of the trailer frame of FIG. 11 showing the rear upright frame tubes also pivoted downward and the direction of the pivot.

FIG. 12B is a side elevational view of the trailer frame of FIG. 12A showing the lower end portions of the rear upright frame tubes released from the bottom frame with the rear upright tubes folded downward.

FIG. 13 is a simplified rear view of a trailer wheel and stub axle, positioned for insertion of the stub axle into the rear axle of the trailer frame.

FIG. 14 is an enlarged, isometric view of the tongue with latch assemblies and a hitch assembly.

FIG. 15 is an enlarged, side elevation view of the hitch assembly showing the elastic strip in broken line.

FIG. 16 is an isometric view of the trailer frame of FIG. 1 with the stroller frame having a seat and canopy inserted in the trailer frame, with the front wheel mounted on the stroller.

FIG. 17 is a simplified isometric view of an alternative embodiment of the trailer showing a stroller frame mounted in the trailer without showing a seat or canopy for the stroller.

FIG. 17A is a simplified isometric view of the retaining pin assemblies of the trailer of FIG. 17.

FIG. 17B is a simplified isometric view of the top and bottom retaining plates, with sides walls, that hold the front frame tubes of the stroller in the trailer of FIG. 17.

FIG. 18 shows the trailer of FIG. 17 with the stroller having a seat.

### DETAILED DESCRIPTION OF THE INVENTION

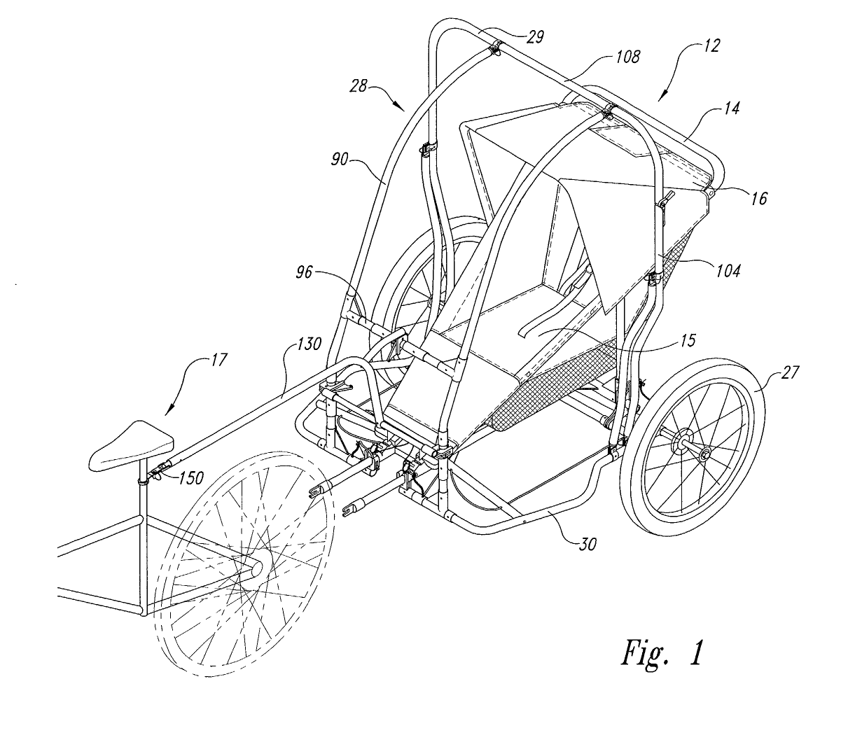

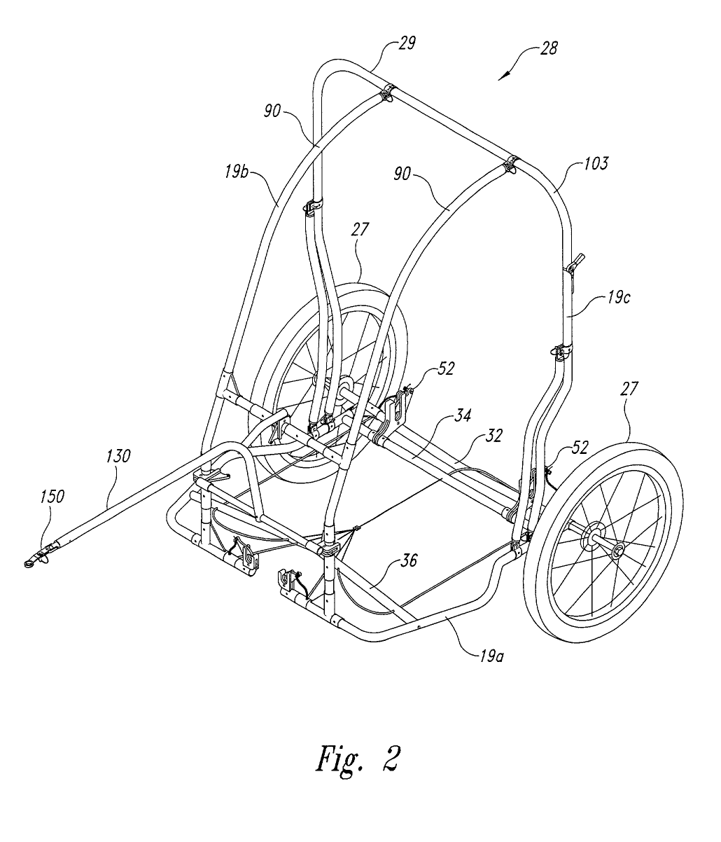

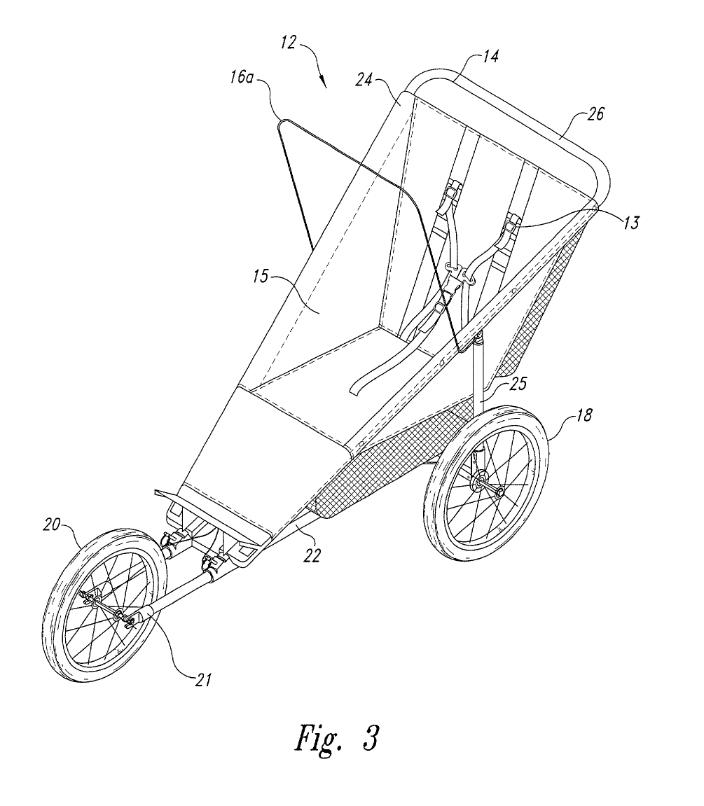

As shown in the drawings for the purposes of illustration, the present invention is embodied in a bicycle trailer 28, shown in FIGS. 1 and 2, in which an unmodified baby stroller 12 with a seat 15 and canopy 16 can be placed, when the stroller's wheels are removed. The bicycle trailer 28 has wheels 27, a frame 29, a towing arm or tongue 130, and a hitch assembly 150. The trailer frame 29 provides a protective enclosure or roll cage for the stroller 12. In operation, the towing arm 130 is attached to the trailer frame 29 at one end and to a bicycle 17 at another end, by use of the hitch assembly 150. When the bicycle is operated, the trailer 28, containing the baby stroller 12 without wheels, is pulled. The baby stroller 12 shown is typically of a type that has removable wheels. The baby stroller 12 can be easily and quickly removed from the trailer frame and the wheels can be replaced, so that the baby stroller can be used in the conventional hand pushed way as desired, as can be seen in FIG. 3.

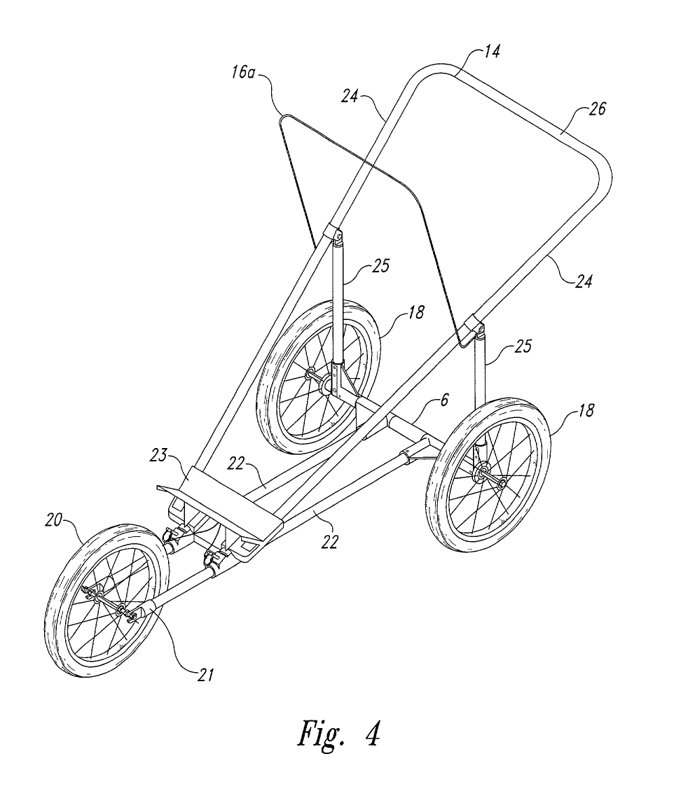

FIGS. 3 and 4 show one embodiment of the typical baby stroller 12 with which the bicycle trailer 28 is used. The baby stroller comprises a frame 14, a seat 15, a restraint system 13, a canopy 16 or canopy support bar 16a, rear wheels 18, and a front wheel 20. The baby stroller frame 14, shown in FIG. 4, is foldable and has a base with base frame tubes 22 and a transversely extending rear axle assembly 6, designed to permit folding of the frame and selective removal of the two rear wheels 18 rotatably mounted to the rear axle assembly 6. The forward end of the stroller frame 14 has a single front wheel 20 rotatably mounted thereto. The stroller frame 14 includes left and right side horizontal base frame tubes 22 extending rearwardly from the front wheel in parallel configuration to the rear axle assembly 6. The stroller frame 14 also includes left and right, downwardly sloping upper frame tubes 24 which extend from a handle 26 used to push the stroller 12, in converging configuration to the base frame tubes 22 at a position near the rearwardmost extent of the front wheel 20. Also, there are left and right upright frame tubes 25 which extend from the rear axle assembly 6, upward to a rearward portion of the upper frame tubes 24. A footrest 23, is affixed to both of the upper frame tubes and rigidly holds the forward portions of the upper frame tubes in a fixed spaced-apart relation. The forward end portions of the base frame tubes 22 extend forward beyond the footrest 23, and fork tips 21 are attached to the forward end portions. The front wheel 20 is removeably and rotatably mounted on and between the fork tips 21.

The trailer frame 29, as shown in FIG. 2, comprises a bottom frame 19a, a front frame 19b, and a rear frame 19c. Each of the bottom, front, and rear frame, comprises a plurality of frame members as discussed below. The trailer frame 29 is complete and operational without requiring any additional frame members. Only the tongue 130, with hitch assembly 150 and wheels 27, are required for pulling the stroller 12 within the protective enclosure of the trailer frame.

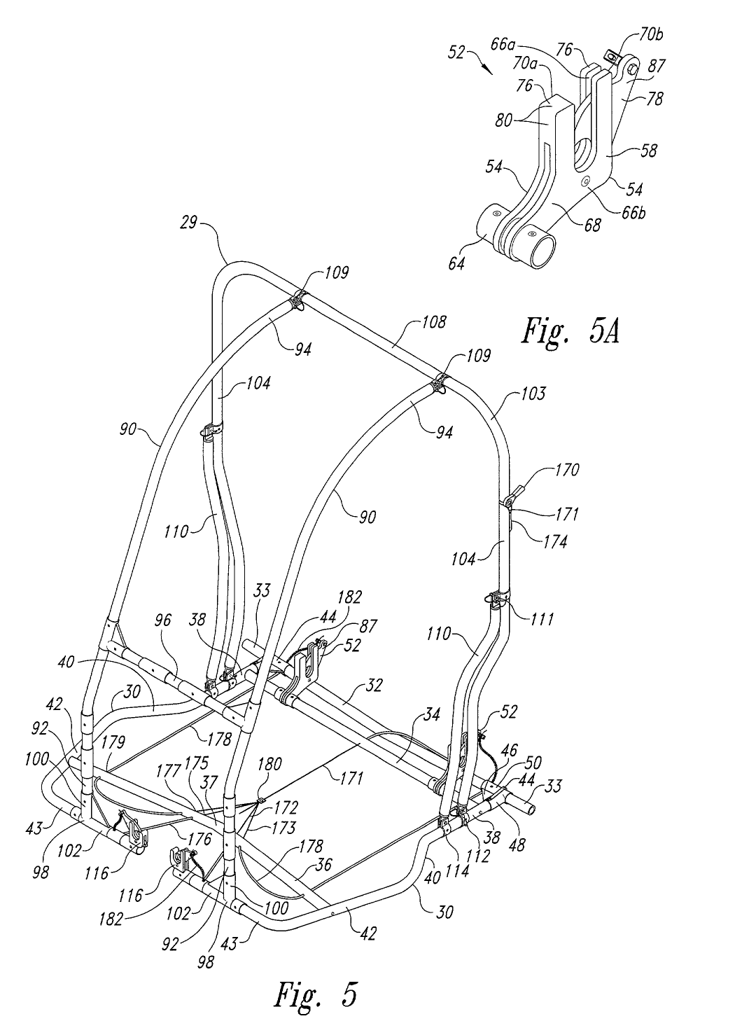

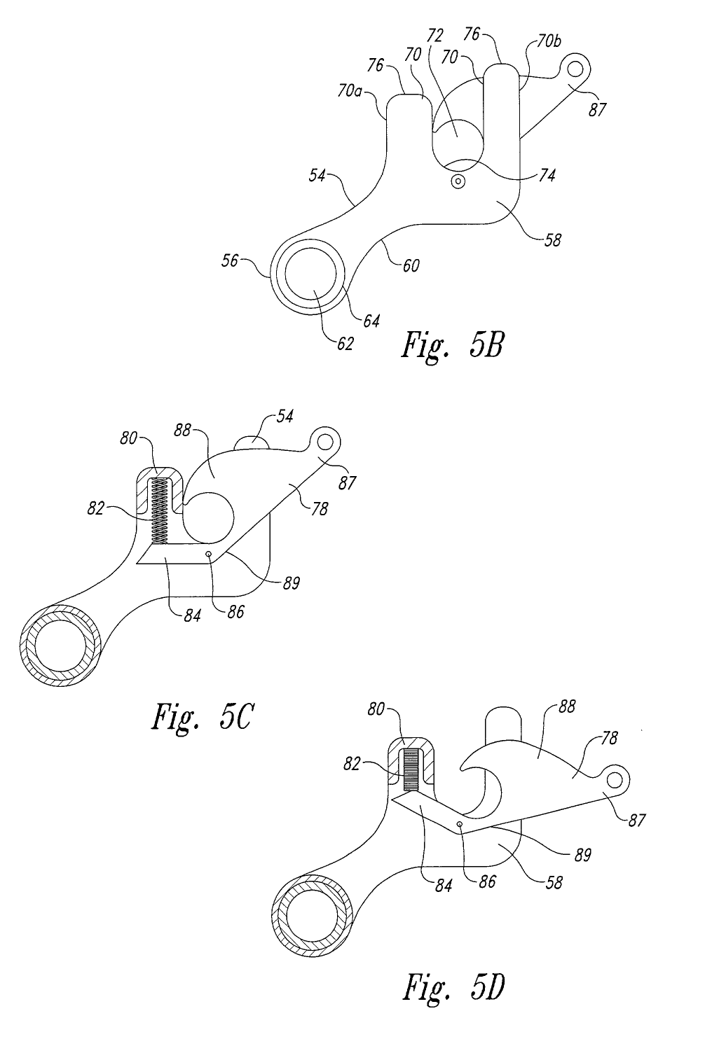

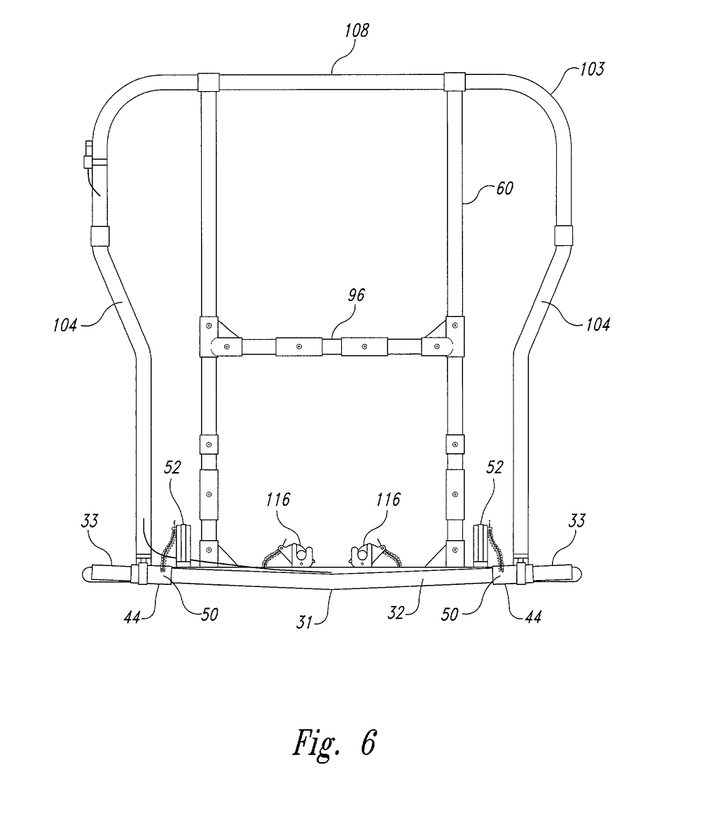

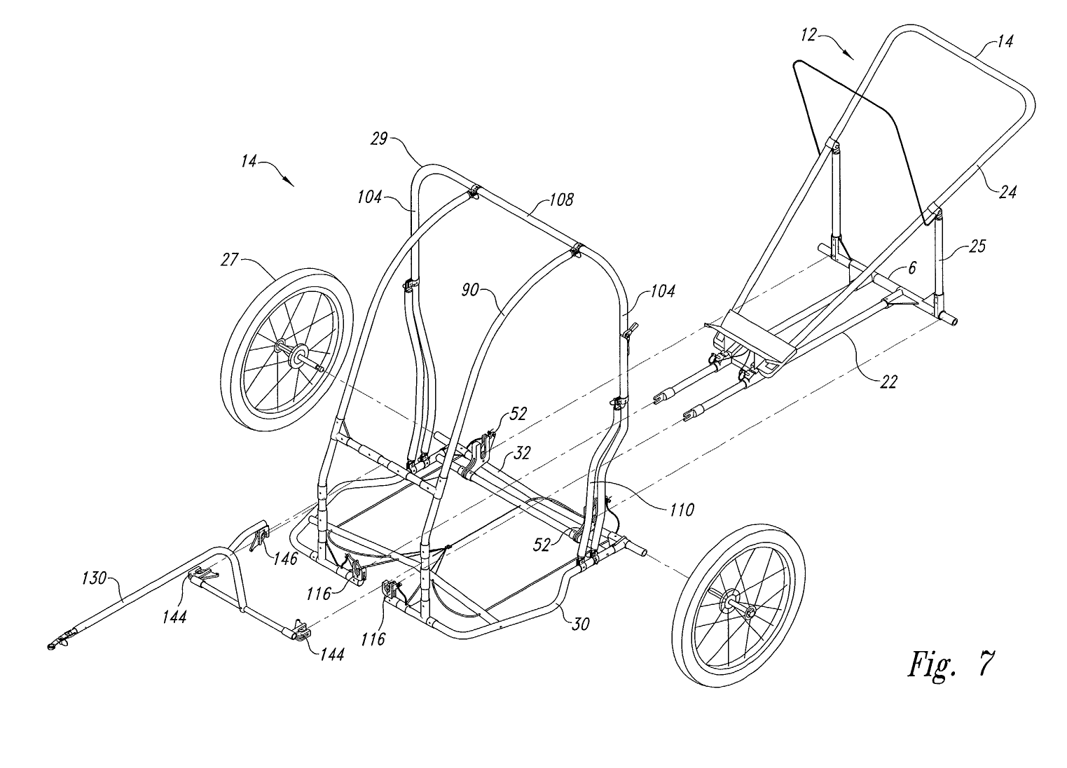

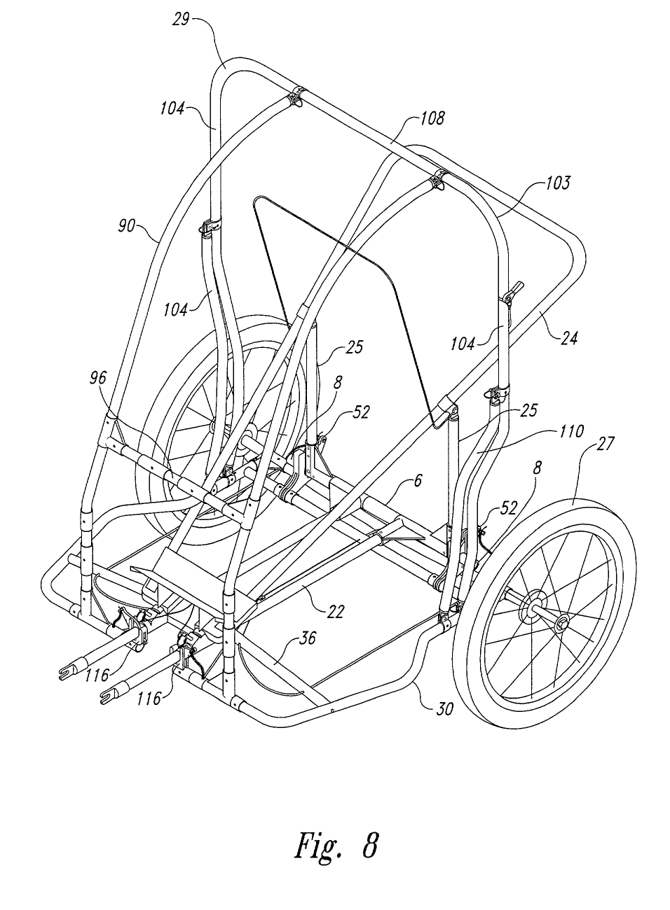

As can be seen in FIG. 5, the bottom frame 19a forms the base of the trailer frame 29, and comprises a tubular rear axle 32, left and right bottom frame tubes 30, an axle latch support tube 34, and a tubular cross bar 36. The rear axle 32 extends laterally with respect to the bottom frame tubes 30, transversely to a longitudinal axis of the stroller about which the bottom frame tubes 30 are symmetrically disposed. As can be seen in FIG. 6, the rear axle 32 has a slight bend 31 midway along the length of the axle, between the left and right ends of the axle. The bend 31 is downward so that the left and right ends of the axle are above the bend 31 with left and right portions of the axle sloping inwardly downward, toward the bend 31, joining at the bend.

As best seen in FIGS. 5 and 6, the left and right portions of the rear axle 32 are transversely and fixedly attached to rearward sections 38 of the left and right bottom frame tubes 30 at the rearwardmost extent of the bottom frame tubes by left and right axle couplers 44. The axle couplers 44 each comprise a frame tube receiver portion 48 and a rear axle connector portion 50. Each frame tube receiver portion 48 and each rear axle connector portion 50 is cylindrically shaped and has an interior cylindrical chamber configured to co-axially receive the corresponding bottom frame tube 30 and rear axle 32 within the portion. Each of the left and right frame tube receiver portions 48 is fixedly and transversely attached to the corresponding axle connector portion 50 and a triangular gusset 46 is disposed between the two portions to rigidify the portions. Rearward ends of the left and right bottom frame tubes 30 are inserted into the frame tube receiver portions 48 and fixed in place with rivets. The bottom frame tubes 30 do not extend rearward beyond the interior chamber of the frame tube receiver portions 48. Left and right end portions 33 of the rear axle 32 extend through the axle connector portions 50 of the axle couplers 44 so that the end portions 33 of the rear axle 32 protrude laterally outward past the axle connector portions 50. The rear axle 32 is also fixedly attached to the axle connector portions 50 with rivets.

Each of the bottom left and right frame tubes 30 have four main sections, including rearward sections 38, diverging sections 40, converging sections 42, and frontal sections 43. The rearward sections 38 extend forward from the axle couplers 44 in slightly inwardly converging and substantially horizontal configuration while remaining spaced-apart from one another. The length of the rearward sections 38, measured along an axis of one of the sections, is about one third the length of the trailer frame 29, the length of the trailer frame being measured along its axis from the rearwardmost extent of the trailer frame 29 to its forwardmost extent.

At forward end portions of the rearward sections 38, the frame tubes 30 bend to extend forward and outward away from one another, forming the diverging sections 40. A longitudinal axis of each of the diverging sections 40 is disposed within a substantially horizontal plane defined by the longitudinal axes of the left and right rearward sections 38. The longitudinal axis of each rearward section 38 extended forward past the rearward section, forms approximately a sixty degree angle with the longitudinal axis of the corresponding diverging section 40.

At forward end portions of the diverging sections 40, the frame tubes 30 bend inward, forming the converging sections 42. Each of the converging sections 42 extend forward in gradually inward converging configuration with one another, such that the rearward ends of the converging sections are laterally outward of the axle couplers 44 and the forward ends of the converging sections 42 are in near lateral alignment with outward portions of the axle couplers 44.

At the forward end portions of the converging sections 42, the frame tubes 30 bend inward to form the left and right frontal sections 43 that extend directly inward toward one another. The axis of the left and right frontal sections 43 are in alignment along an axis extending laterally across the forwardmost extent of the trailer frame 29. The left and right frontal sections 43 extend inward toward one another but do not completely converge so that there is a space between inward end portions of the frontal sections 43.

The axle latch support tube 34, best seen in FIG. 5, extends laterally across the bottom frame 19a with left and right ends of the support tube 34 fixedly attached to the corresponding left and right frame tubes 30. The axle latch support tube 34 is positioned just forward of the rear axle 32.

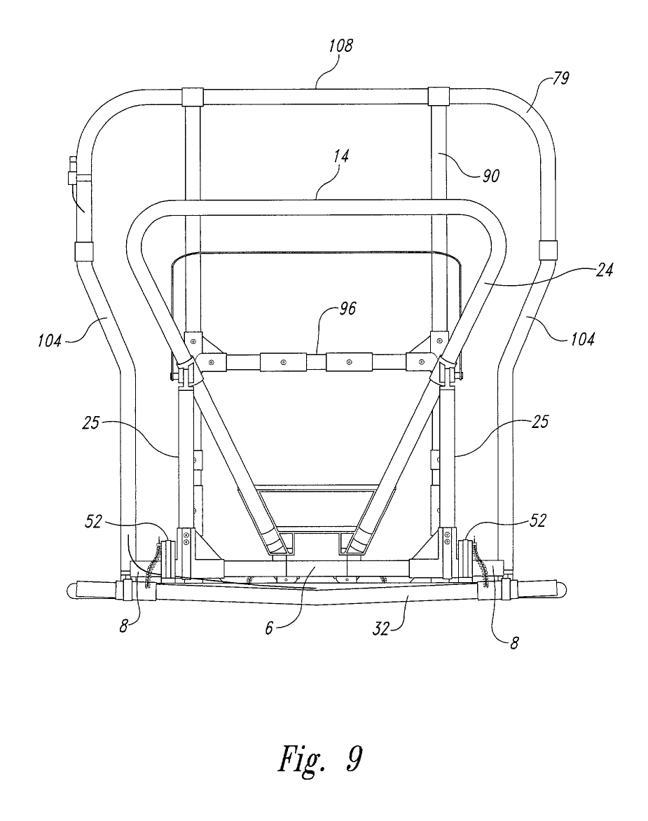

As illustrated in FIG. 5, there are left and right axle latch assemblies 52 fixedly attached to the axle latch support tube 34. The axle latch assemblies 52 are locking mechanisms configured to be able to engage and lock left and right tubular outer end portions 8 of the rear axle assembly 6 of the baby stroller frame 14 to the trailer 28 when the stroller 12 is placed within the trailer frame 29, as can be seen in FIGS. 8 and 9. FIGS. 8 and 9 illustrate that the left and right axle latch assemblies 52 are spaced apart longitudinally along the latch support tube 34, at a distance just greater than the distance between the upright frame tubes 25 of the stroller, such that the rear axle 6 of the stroller can be placed within the latch assemblies 52, with both the left and right axle latch assemblies 52 positioned outside of the upright frame tubes 25.

As illustrated in FIG. 5, near the frontal sections 43 of the bottom frame tubes 30, the tubular cross bar 36 extends laterally across the bottom frame 19a between the bottom frame tubes 30. The tubular cross bar has a slight rearward bend 37 midway along the length of the cross bar, between left and right ends of the cross bar. The bend 37 is rearward so that the left and right ends of the cross bar 36 are positioned forward of the bend 37 with left and right portions of the cross bar extending inward and rearward from the ends, joining at the bend 37. The left and right ends of the cross bar 36 are fixedly attached to one of the corresponding left and right bottom frame tubes 30 at the converging sections 42 of the frame tubes 30.

The front frame 19b of the trailer frame 29 includes left and right parallel front frame tubes 90. Each of the left and right front frame tubes 90 is fixedly coupled to a corresponding one of the left and right frontal sections 43 of the bottom frame tubes 30 at a lower end portion 92 thereof. From the lower end portion 92, each front frame tube rises or extends upward and curves gradually toward the rearward end of the trailer. An upper end portion 94 of each front frame tube 90 is thus rearward and above the lower end portion 92. The upper end portion 94 of each front frame tube is positioned above the axle latch support tube 34. As can be seen in FIGS. 5 and 6, a hitch bar 96 extends laterally and transversely between the parallel front frame tubes 90. The hitch bar 96 is positioned vertically midway between the top and bottom of the trailer frame 29.

The front frame tubes 90 are pivotally connected to the frontal sections 43 of the bottom frame tubes 30 by front couplers 98. The front couplers 98 each comprise a front frame tube receiver portion 100 and a frontal section connector portion 102. The frame tube receiver portion 100 and frontal section connector portion 102 are fixedly and transversely attached. In addition, there is a triangular gusset disposed between the two portions to rigidify the connection. Each of the portions is cylindrical in shape and has a cylindrical interior chamber sized to receive a corresponding tubular portion of the trailer frame 29. Each of the bottom end portions 92 of the front frame tubes 90 is inserted into the corresponding front frame tube receiver portion 100 and fixedly attached therein with a rivet. Each of the frontal section connector portions 102 is rotatably fit about a corresponding one of the frontal sections 43 and held in place along the length of the frontal section 43 by fixedly attached sleeves, on either side of the connector portion 102. The rotatably attached frontal section connection portions 102 permit the front frame tubes 90 to pivot about an axis extending through the frontal sections 43.

In one alternative embodiment, the left and right front frame tubes 90 are each divided into two sections, a top section and a bottom section. The break between the top and bottom sections, wherein a releasable connections is disposed, is located at a height on the front frame tubes just above the hitch bar 96.

The rear frame 19c of the trailer frame 29 includes a rear frame tube 103 with left and right upright frame sections 104 and a horizontal frame section 108, with the upright sections and horizontal section being integrally formed. The horizontal frame section 108 extends laterally and transversely between the upper end portions of the upright frame sections 104. Each of the left and right upright frame sections has a lower end that is pivotally connected to a corresponding one of the left and right bottom frame tubes 30 by a pivoting connection 112. The upright frame sections 104 rise or extend upward from their lower ends and at their uppermost portions, bend inward toward one another and are joined together by the horizontal frame section 108. The upper end portions 94 of the left and right front frame tubes 90 are each releasably connected to the horizontal frame section 108 by removable pins 109 that are securely inserted through connecting members on both the upper ends portions 94 of the front frame tubes and the horizontal frame section 108. The pivoting connections 112 at the lower ends of the upright frame sections 104 allow the upright frame sections to pivot about a lateral axis parallel to and proximate the axle latch support tube 34.

Left and right upright support tubes 110 support the upright sections 104 of the rear frame tube 103. The support tubes 110 are each positioned adjacent and forward of a corresponding one of the upright frame sections 104. The lower ends of the support tubes 110 are connected to the bottom frame tubes 30 by second pivoting connections 114 just forward of the pivoting connections 112 of the upright frame sections. The second pivoting connections 114 permit the support tubes to pivot about a lateral axis parallel to the axle latch support tube 34, aligned just forward of and proximate the pivoting connections 112 of the upright frame sections 104. Each of the upper end portions of the left and right support tubes 110 are releasably connected to the corresponding left and right upright frame sections 104 at about the height of the hitch bar 96. The releasable connections comprise fixedly attached connecting members on both the upright frame sections 104 and the upper end portions of the support tubes 110 that are held together by removable pins 111.

The position of the frame tubes of the trailer frame 29, which are disposed about the perimeter of a stroller frame 14 second within the trailer frame, at left and right sides of the stroller frame, and in front of the stroller frame, help provide protection for a baby in the trailer. As can be seen in FIG. 1, the bottom frame tubes 30, front frame tubes 90, horizontal section 108, and upright frame sections 104 of the rear frame tube 103, and hitch bar 96, form a “roll cage” type configuration around the seat 15 of the stroller 12, providing a protective enclosure.

As illustrated in FIG. 5A, each of the left and right axle latch assemblies 52, which are locking mechanisms for selectively securing the axle 6 of the stroller frame 14 within the trailer frame 29, is comprised of two spaced-apart flat retainer pieces 54 positioned adjacent one another in parallel planes, with a latch 78 disposed between the retainer pieces 54. FIGS. 5 and 5A in combination show that each of the pair of flat retainer pieces 54, for each latch assembly 52, is aligned along a vertical and longitudinal plane with respect to the trailer 28. The planes are thus transverse to the axis of the axle latch support tube 34. Each flat retainer piece 54 has an inner planar surface 66a and outer planar surface 66b, with the inner surfaces of each pair of retainer pieces facing one another and the outer surfaces facing away from one another. The thickness of each retainer piece 54 is about ¼ inch in one embodiment. Each retaining piece has a flat edge 68 around the perimeter of the piece between the inner and outer planar surfaces 66 of the pieces. The surface of the flat edge 68 is transverse to the inner and outer planar surfaces 66. FIG. 5B shows that the contour of each flat retainer piece 54, as viewed from either side of the vertical plane of the piece. The contour comprises a partial circular section 56 at a forward end portion of the retainer piece 54, a forked section 58 at the rearward end portion of the retaining piece 54, and a more narrow bridging section 60 joining the circular section 56 and forked 58 section. The contour of the forked section 58 of the retainer piece includes two adjacent vertical members 70 with a center space 72 there between. At the bottom of the center space 72 the contour of the piece is formed with a circular segment shape. The surface of the flat edge 68 of each retaining piece 54 at the bottom of the center space 72 thus has a curvature with constant radius, to form a resting surface 74 upon which the tubular outer end portions 8 of the rear axle assembly 6 of the stroller 12 can rest snugly.

A circular bore 62 is centered within the circular section 56 of each retainer piece. The circular bore 62 is sized to receive the axle latch support tube 34 there through. For each retainer piece 54, there is also a cylindrical stub member 64 with an interior diameter nearly equal to the diameter of the bore, aligned with the bore and welded to the retainer piece 54. One stub member 64 is welded to the outer planar surface 66b of each retainer piece so that there is an inward extending stub and an outward extending stub for each axle latch assembly. Rivets fix each cylindrical stub member 64 to the axle latch support tube 34.

As shown in FIGS. 5A and 5B, for the vertical members 70 of the forked section 58 of each retainer piece 54 includes a forward vertical 70a member and a rearward vertical member 70b. As seen in FIGS. 5A and 5C, the two forward vertical members 70a of each axle latch assembly 52 are joined together at their upper end portions 76 by a retaining wall 80. The wall 80 joins the two inner planar surfaces 66a of the two forward vertical members 70a. The wall extends around the perimeter of the inner surfaces 66a at the upper end portions 76 of the forward vertical member 70a as well as partially down both sides of the forward vertical members 70a. As illustrated in FIG. 5C, there is a biasing member or rear axle latch coil spring 82 disposed between the two retaining pieces 54 of each axle latch assembly 52. The axle latch spring 82 is aligned such that the axis of the spring extends vertically with an upper end of the spring resting against the retaining wall 80, so that the spring can be compressed against the retaining wall 80.

As shown in FIG. 5C, the rear axle latch 78 has a spring contact portion 84, a contiguous lever 87, a pivot portion 89, and a retaining hook 88, all formed together in a single piece, with the spring contact portion 84 and retaining hook 88 disposed on different sides of the pivot portion 86. The contiguous lever 87 is formed on a convex side of the retaining hook 88. The axle latch 78 is a substantially flat and planar piece, disposed between the two retainer pieces 54 of the axle latch assembly 52, and has a flat edge as does each of the retainer pieces. The axle latch 78 is pivotally mounted on a pivot pin 86 between the two retainer pieces 54 that allows the axle latch 78 to pivot within the plane of the latch, about an axis transverse to the retaining pieces 54, centered proximate the resting surface 74 of the retainer pieces 54. As shown in FIGS. 5C and 5D, the axle latch 78 is further disposed such that it can be pivoted about the pivot pin 86 to selectively position the retaining hook 88 above the resting surface 74, when the latch is closed, or to withdraw the retaining hook 88 between the two retainer pieces 54 when the latch is open. The concave portion of the retaining hook 88 has a rounded contour that can fit snugly against an upper portion of the tubular rear axle 6 of the baby stroller 12 when the rear axle is disposed on the resting surface 74 and the latch is closed.

As shown in FIG. 5C, the spring contact portion 84 is disposed below the axle latch coil spring 82 and contacts the lower end of the coil spring. A restoring force supplied by the coil spring 82 pushes down on the spring contact portion 84, which in turn tends to close the axle latch 78 by causing it to pivot so that the retaining hook 88 closes over the resting surface 74. When one of the tubular outer end portions 8 of the rear axle assembly 6 of a stroller 12 is placed within the resting surface 74 and the restoring force of the spring closes the latch, the axle is locked within the center space 72 of the axle latch assembly 52 in that the latch 78 cannot be pivoted open by force exerted by the axle. The pivoting of the axle latch 78 in the opposite direction opens the center space 72 to permit removal of the stroller axle 6.

As can be seen in FIGS. 5 and 8, there are also front latch assemblies 116 that are locking mechanisms for securing the base frame tubes 22 of the stroller frame 14 within the trailer frame 29. They are substantially similar to the axle latch assemblies 52. However, the retainer pieces of the front latch assemblies are without bridge sections 60 or partial circular 56 sections. Instead, the bottoms of the forked sections of the front latch assemblies 116 are directly attached to the frontal sections 43 of the bottom frame tubes 30. The left and right front latch assemblies 116 are each attached to a corresponding ones of the left and right frontal sections 43. The front latch assemblies 116 are disposed such that the concave portions of the retaining hooks face one another when the latches are open. The retainer pieces of the latch assemblies are thus oriented in a vertical and lateral plane, transverse to the vertical and longitudinal plane in which the retainer pieces 54 of the axle latch assemblies 52 are disposed. As such, the forward end portions of the parallel base frame tubes 22 of the stroller frame 14 can be placed within the resting surface of the front latch assemblies 116 when the stroller 12 is placed within the trailer frame 29.

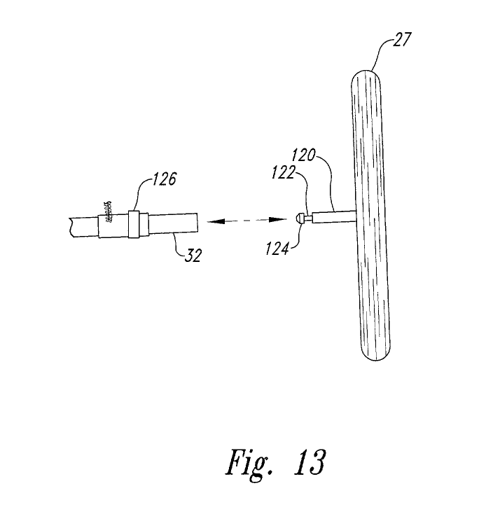

The wheels 27 of the trailer 28 are removably attached to the rear axle 32 of the trailer. The removable wheel assembly is substantially similar to that disclosed in U.S. Pat. No. 5,476,275. The wheels 27 are rotatably mounted on a stub axle 120, as best seen in FIG. 13. The stub axle 120 has a circumferential groove 122 and a circumferential bevel 124 that forms a tapered end on the stub axle. The tubular rear axle 32 of the trailer 28 is sized to receive the stub axles 120 of the wheels 27, coaxially, through openings on its left and right ends. When the stub axles 120 are inserted into the tubular rear axle 32, inward end portions of the stub axles are retained within the rear axle 32 by releasable lock mechanisms. Each of the lock mechanisms includes the circumferential groove 122 on the stub axle 120, and a movable pin (not shown in FIG. 13) on the rear axle 32 that extends through an aperture in the rear axle 32, into an interior chamber of the rear axle. When the stub axles 120 are inserted into the trailer axle 32, an inner portion of the movable pin projects into the groove 122 of the stub axle 120 to prevent withdrawal of the stub axle 120. The outer portion of the pin, outside the rear axle 32, is formed integral with a strip spring 126 on the outside of the rear axle 32. The restoring force of the strip spring 126 biases the pin inward toward the interior of the rear axle 32 holding the pin in place projecting into the circumferential groove 122 of the stub axle 120. When it is desired to do so, a slight manual force can be applied against the restoring force of the strip spring 126 which in turn, withdraws the movable pin from within the circumferential groove 122 so that the wheel 27 can be easily removed. As the rear axle 32 of the trailer 28 has a downward bend 31, the stub axles 120 are positioned in a downwardly inward angle when inserted into the rear axle. As such, the plane of the wheels 27 is canted or tilted so that the bottom portion of the wheels 27 are positioned laterally outward of the top portion of the wheels. The tilted configuration of the wheels 27 with the bottom portion of the wheels laterally outward of the top portion, provides the trailer with a wider base and greater stability.

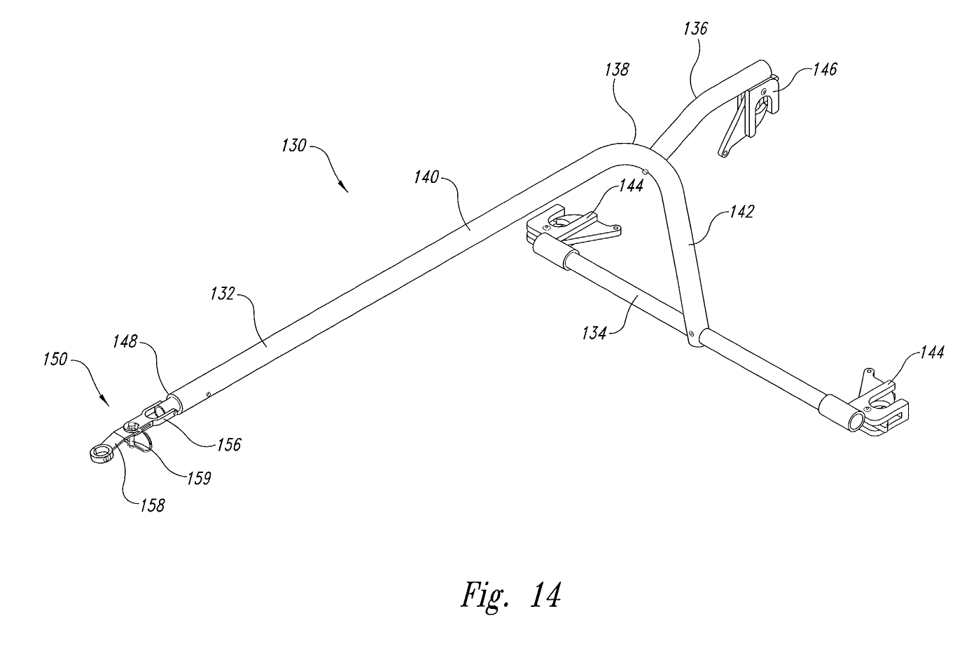

As shown in FIGS. 1 and 14, the tongue or towing arm 130, is used to hitch the trailer 28 to the bicycle 17. The tongue or towing arm 130 is formed from first 132, second 134, and third 136 cylindrical or tubular sections. The first section 132 has a horizontal and elongated portion 140 with a forward end portion 148 and a single downward bend 138, proximate the rearward end of the tongue. A downward extending portion 142 extends downward and rearward from the bend. The second section 134 is horizontally and fixedly attached to the bottom end of the downward extending portion 142 and extends laterally with respect to the trailer 28. Lastly, the third section 136 is fixedly attached to the first section 132 at the convex side of the bend 138. Latch assemblies 144 and 146, substantially similar to the front latch assemblies previously described, are fixedly attached to the second and third sections 134 and 136 of the tongue 130a. A lower latch assembly 144 is attached to each of the left and right ends of the second section 134, and an upper latch assembly 146 is fixedly attached to the rearwardmost end of the third section 136. The latch assemblies 144 and 146 are positioned on the tongue 130 so that it can be aligned with the trailer 28 with each of the lower latch assemblies 144 engaged and locked to a lower portion of one of the left and right front frame tubes 90 and the upper latch assembly 146 engaged and locked to the hitch bar 96.

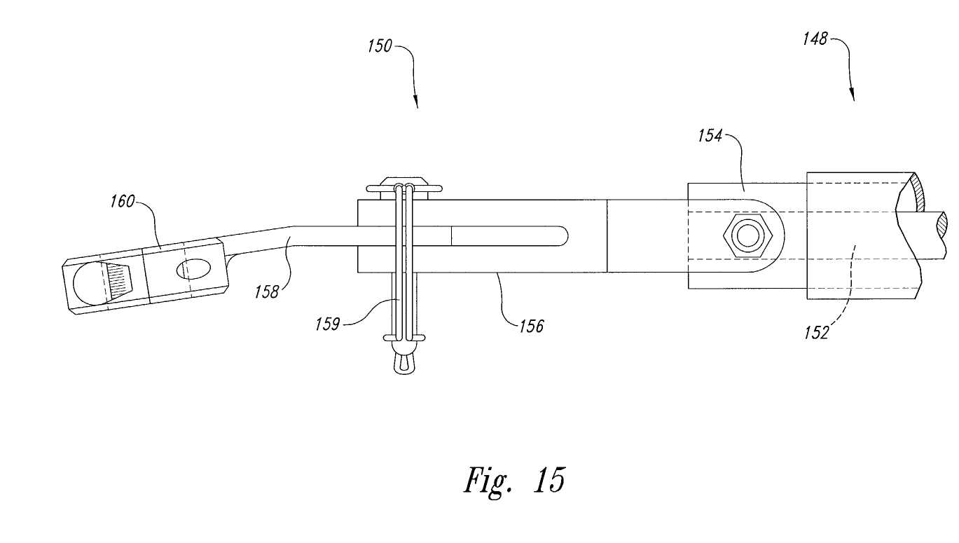

As shown in FIGS. 14 and 15, a hitch assembly 150 is flexibly attached to the forward end portion 148 of the tongue 130. An elastic cylindrical strip 152 is inserted longitudinally within an interior cylindrical chamber of the tongue 130 through an opening at the forward end of the tongue. The elastic strip 152 is fixedly attached to the inside wall of the tongue 130 and a solid cylindrical sleeve 154 is fixedly attached to a forward end portion of the strip 152 which protrudes from the tongue 130. The cylindrical sleeve 154 is disposed such that it is aligned coaxially with the forward end portion 140 of the tongue 130 at the forward end portion thereof. The hitch assembly 150 has a rearward portion or arm 156 and a forward portion or arm 158. The rearward arm 156 and forward arm 158 are pivotally connected by a removable pin 159 inserted through apertures in both arms. The pin 159 is vertically disposed so that the forward arm 158 is able to pivot horizontally about the vertical axis of the pin. A hitch 160 is formed integral to the forward arm 158 and can be attached to the bicycle 17, thereby connecting the trailer 28 to the bicycle.

As is best seen in FIG. 5, a remote manually operable lever 170 is located on the left upright frame section 104 of the rear frame tube 103, near the top of the frame section for convenient access by a user. A first flexible cable conduit 174 extends down from an end proximate the lever 170, on the outside surface of the left upright frame section 104, into an aperture in the frame section, and down the length of the section 104 in its interior chamber. The cable conduit 174 exits the upright frame section near the left bottom frame tube 30 through another aperture and extends laterally across the trailer 28 to an aperture located on a rearward facing portion of the axle latch support tube 34, in the center of the latch support tube 34, midway between the ends of the tube. The first conduit 174 terminates at the axle latch support tube 34. There is another aperture, diametrically opposed to the first, on a forward facing portion of the axle latch support tube 34. Both of the apertures in the axle latch support tube extend through the wall of the support tube.

There are six apertures on a rearward facing portion of the tubular cross bar 36, three on either side of the bend 37 in the cross bar. The two outside apertures on the cross bar 36, located at positions 179, one on either side of the bend 37, are positioned proximate to corresponding ones of the left and right bottom frame tubes 30. The inside four apertures, two on either side of the bend 37, are located at positions 175 and 177, positioned proximate one another and proximate the bend 37. Of these four inside apertures, there are two inner apertures, located at positions 177, and two innermost apertures, located at positions 175, the innermost apertures being positioned laterally inward of the inner apertures, toward the bend 37. There are also six corresponding apertures on a forward facing portion of the tubular cross bar 36, each diametrically opposed to one of the six apertures on the rearward facing portion of the cross bar. All of the apertures extend fully through the wall of the tubular cross bar 36. Second flexible cable conduits 176 extend from each of the two innermost apertures of the forward facing portion of the tubular cross bar 36, to rearward facing apertures on each of the frontal sections 43 of the bottom frame tubes 30, terminating at the frontal sections 43. Third flexible cable conduits 178 extend from each of the two inner apertures of the forward facing portion of the tubular cross bar 36, laterally outward, to each of the two outer apertures, also on the forward facing portion of the tubular cross bar 36. The third flexible cable conduits 178 also extend back through the tubular cross bar, exiting through the outside apertures on the rearward facing portion of the cross bar 36, and extend back to forward facing apertures on the tubular rear axle 32 of the trailer, terminating at the axle.

A first cable 171 is attached at one end to the remote lever 170 and passes down through the length of the first cable conduit 174, and the apertures on the axle latch support tube 34, and extends forward out of the axle latch support tube 174 to a cable clamp 176 disposed along the center axis of the trailer 28 between the axle latch support tube 34 and the tubular cross bar 36. Two second cables 172 extend from the cable clamp 180, in diverging configuration, forward and outward, to the innermost apertures, located at positions 175 on the cross bar 36, entering the cross bar through the innermost apertures and exiting into the second cable conduits 176. Each of the second cables 172 pass through the length of the second flexible cable conduits 176 into apertures on a corresponding one of the frontal sections 43 of the bottom frame tubes 30, and exit the frontal sections 43 through apertures located on upward facing portions thereof. From there, the second cables 172 extend coaxially through coil spring conduits 182, to contiguous levers on the front latch assemblies 116. Two third cables 173 also extend from cable clamp 180 in diverging configuration, forward and outward, to the inner apertures, located at positions 177 on the cross bar 36, entering the cross bar through the inner apertures and exiting into third cable conduits 178. Each of the third cables 173 pass through the length of the third cable conduits 178, entering the forward facing apertures on tubular trailer rear axle 32, and exiting the rear axle 32 through apertures on an upward facing portion of the axle. From there, the third cables 173 extend upward through coil spring conduits 182 to the contiguous levers 87 of the axle latch assemblies 52.

The remote lever 170 can be used to activate the front and axle latch assemblies 116 and 52 in that it can be easily rotated to pull or retract the first cable 171, which in turn retracts the second cables 172 and third cables 173. When the second 172 and third 173 cables are retracted, the contiguous levers on the front latch assemblies 116 and axle latch assemblies 52 are pulled, pivoting the latches, thus withdrawing the retaining hooks and unlocking the latch assemblies so that the bottom frame tubes 22 and tubular outer end portions 8 of the rear axle assembly 6 of the stroller 12 can be placed in or withdrawn from the latch assemblies 52 and 116.

No modifications need be made or adaptive members need be added to the stroller frame 14 of the stroller 12 for it to be fit within or towed in the trailer 28. When it is desired to tow the stroller 12 by bicycle 17 in the trailer 28, the operator prepares the stroller by simply removing the front 20 and rear wheels 18 of the stroller. The remote lever 170 on the trailer is turned to open or unlock the axle latch assemblies 52 and front latch assemblies 116. As best seen in FIG. 7, the stroller frame 14 is then mounted or inserted into the trailer frame 29 through the rear frame tube 103 from the back of the trailer, and through a space defined by the horizontal sections 108, left and right upright sections 104, and the trailer rear axle 32. None of the trailer frame members need be moved, removed, or repositioned to insert or mount the stroller frame 14 within the trailer. Once the stroller frame 14 is inserted through the space the operator aligns the stroller frame 14 such that the tubular outer end portions 8 of the rear axle assembly 6 rest in the rear axle latch assemblies 52 and the forward end portions of the base frame tubes 22 rest in the front latch assemblies 116. The remote lever 170 can then be turned again to lock the latch assemblies 52 and 116, thereby securing the stroller 12 within the trailer 28, as shown in FIGS. 8 and 9. The stroller frame 14 can be conveniently removed from the trailer 28 when desired, by turning the remote lever 170 to again open or unlock the front latch assemblies and axle latch assemblies 116 and 52, and lifting and pulling the stroller frame 14 up and out through the space in the back of the trailer through which it was inserted.

The location of the remote lever 170 near the top of the upright frame section 104 in the rear of the trailer provides for ease of use. The user can insert and lock the stroller 12 into the trailer without manipulating each latch assembly independently.

If the tongue 130 is not attached the operator can easily align and attach the lower left and right latch assemblies 144 of the tongue 130 to the left and right front frame tubes 90 and its upper latch assembly 146 to the hitch bar 96 (see FIG. 7). As is best illustrated in FIGS. 14 and 15, it may be desired to normally leave the hitch 160 of the hitch assembly 150, attached to the seat bar of a bicycle 17 for convenience. In that circumstance, whenever it is desired to release the tongue 130 from the bicycle, the removable pin 159 of the hitch assembly 150 is simply removed, freeing the rearward arm 156 from the forward arm 158 of the hitch assembly, thus freeing the tongue from the bicycle. In the alternative, the hitch assembly 150 may be selectively detached from the bicycle.

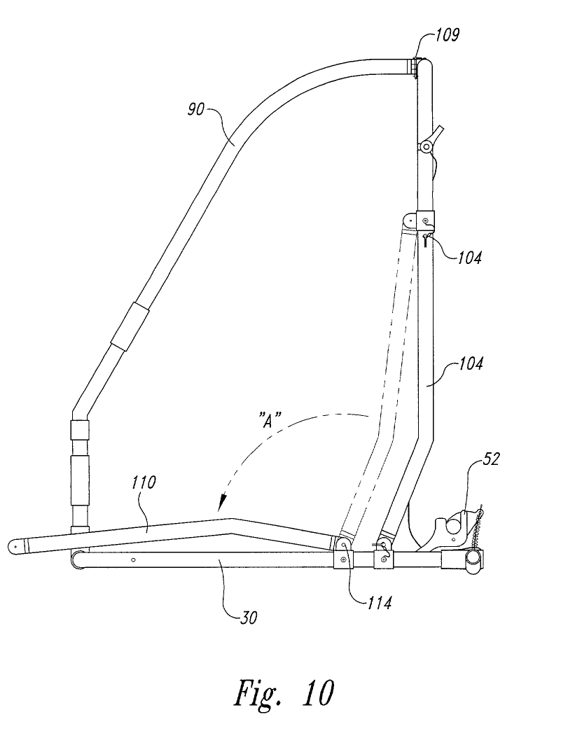

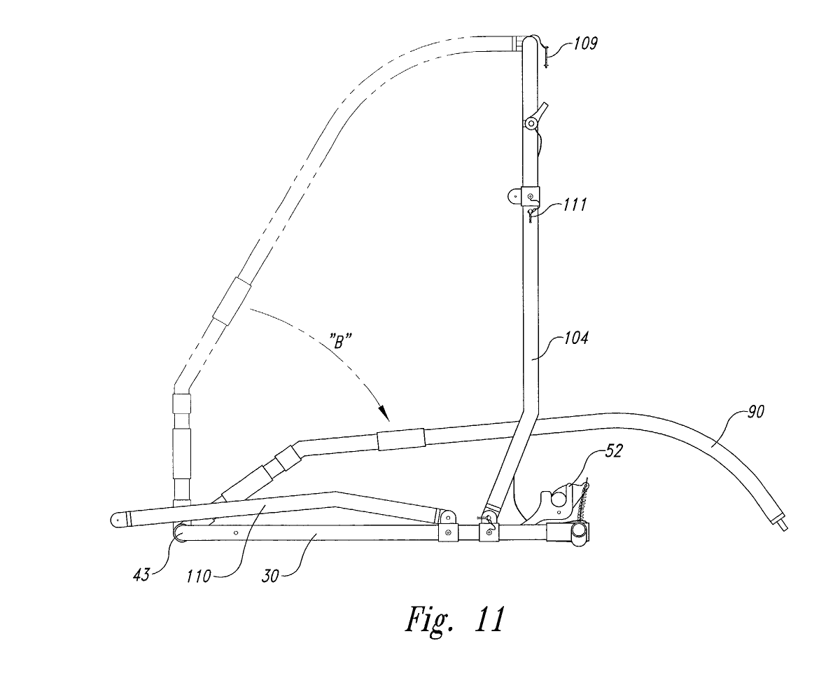

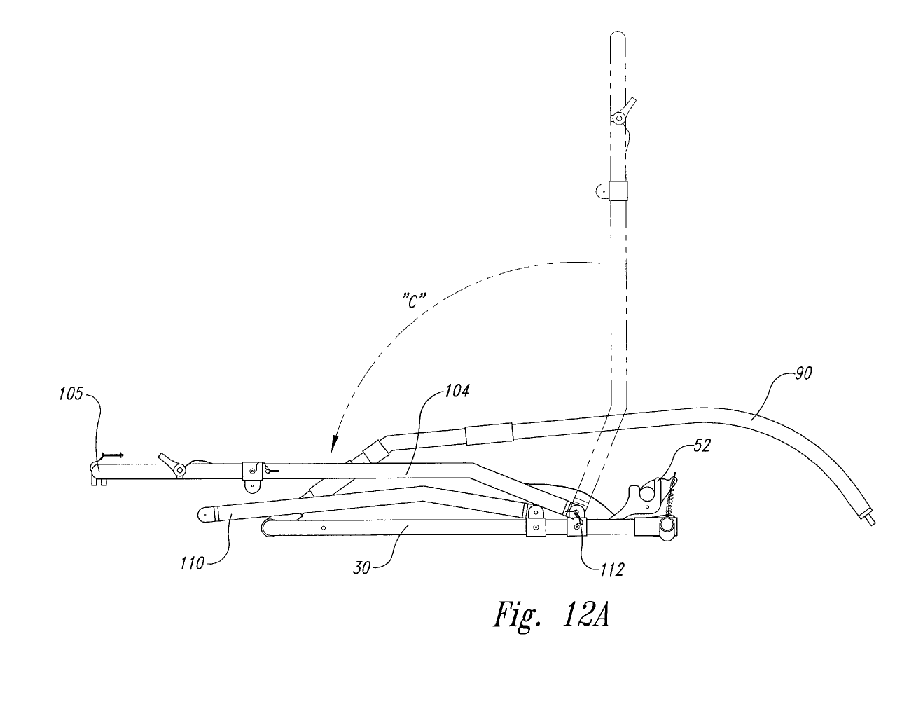

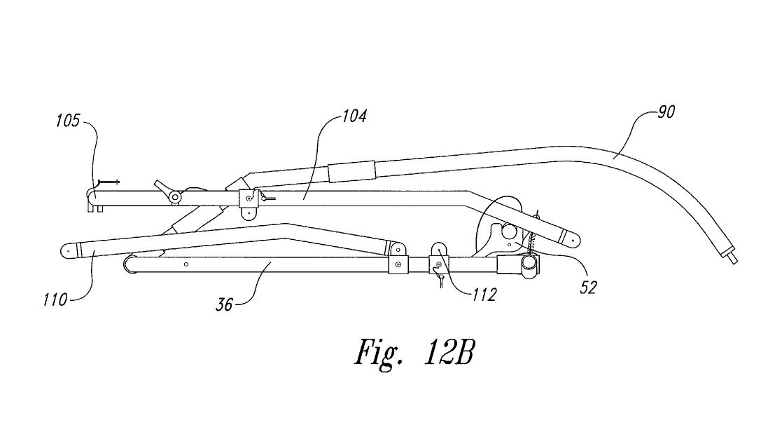

The user of the trailer 28 may desire to store or transport the trailer in a compact mode. As discussed above, the rear wheels 27 of the trailer can be easily removed and the tongue 130 can be detached. In addition, as illustrated in FIGS. 5, 10, 11, 12A and 12B, the trailer 28 can be folded. One way to do so comprises the following steps: The user removes the removable pins 111 that connect the upper end portions of the support tube 110 to the upright frame sections 104. As illustrated in FIG. 10, the user can then pivot the support tubes 110 forward and downward, about the axis of the pivoting connections 114, toward the front of the trailer 28, in the direction of arrow “A”. The user also removes the pins 109 that connect the upper end portion of the front frame tubes 90 to the horizontal frame section 108. As illustrated in FIG. 11, the front frame tubes 90 can then be pivoted downward and rearward, in the direction of arrow “B”, about the axis of the frontal sections 43, toward the rear of the stroller. Lastly, the upright frame sections 104 can be pivoted forward about the pivoting connection 112, such that the upright sections 104 fold downward and forward in the direction of arrow “C” as shown in FIG. 12A. Alternatively, the pivoting connection 112 can be easily disassembled as it comprises a removable pin inserted through connecting members on the lower end portions of upright frame sections 104 and on the bottom frame tubes 30. As illustrated in FIG. 12B, the user can easily remove the pin of the pivoting connection 112 and position the upright frame sections 104 against the bottom frame tubes 30 so that the upper end portions 105 of the upright frame sections 104 are nearly longitudinally aligned with the frontal sections 43 of the bottom frame tubes 30.

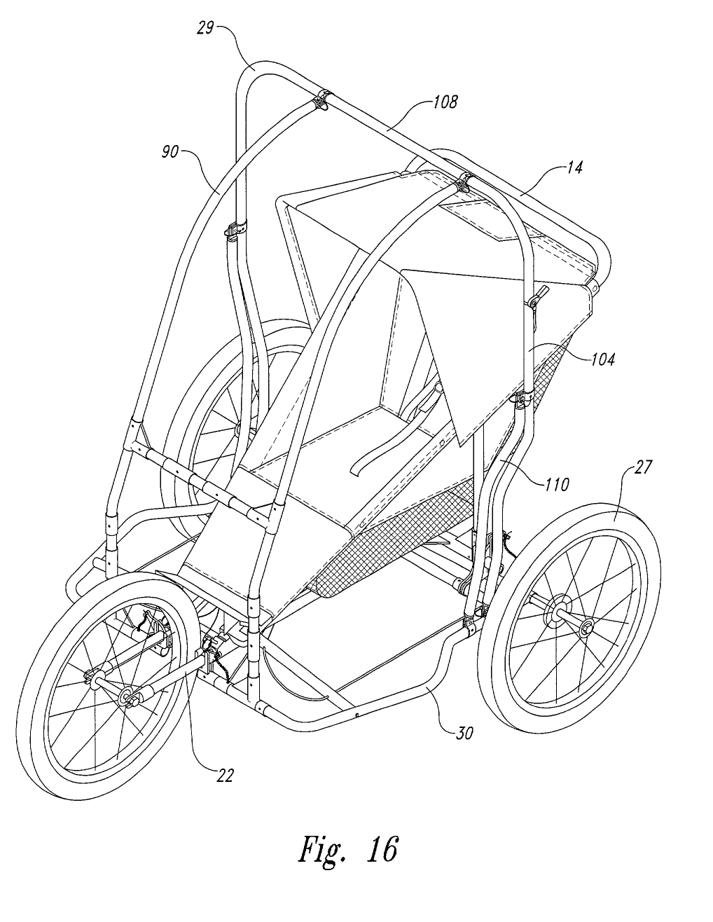

As seen in FIG. 16, the front wheel 20 of the stroller 12, with a diameter similar to the wheels 27 of the trailer 28, can be rotatably mounted to the stroller frame while it is secured within the trailer frame 29 with the tongue 130 removed. In this configuration the stroller and the trailer frame 29 can be pushed about much as a normal stroller but with the protection of a roll cage.

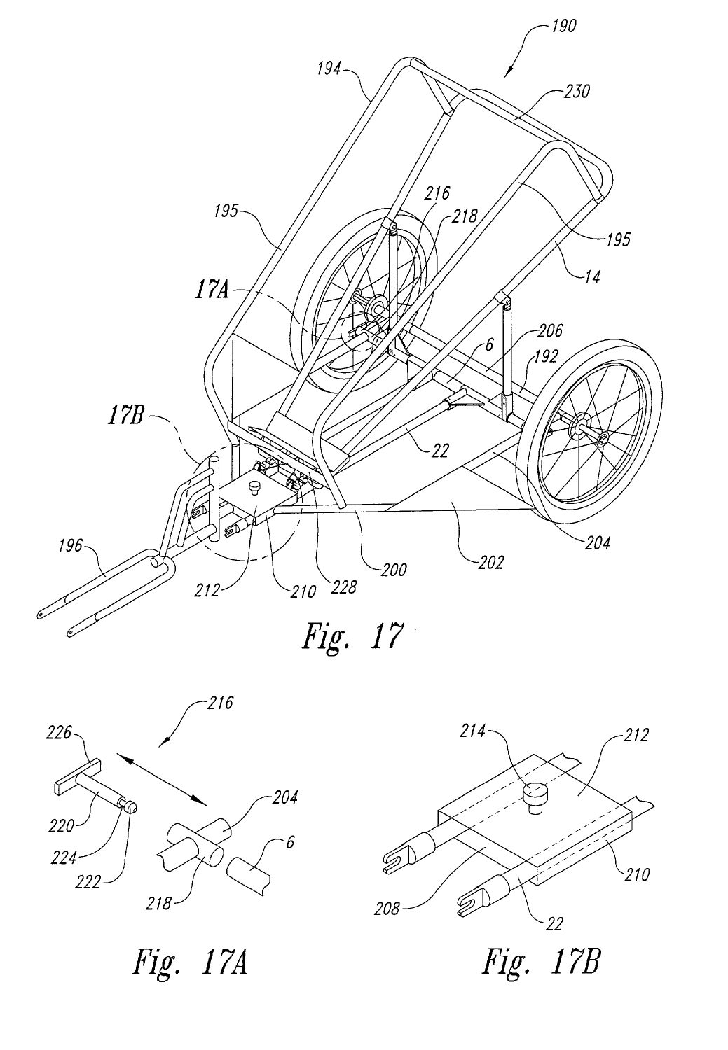

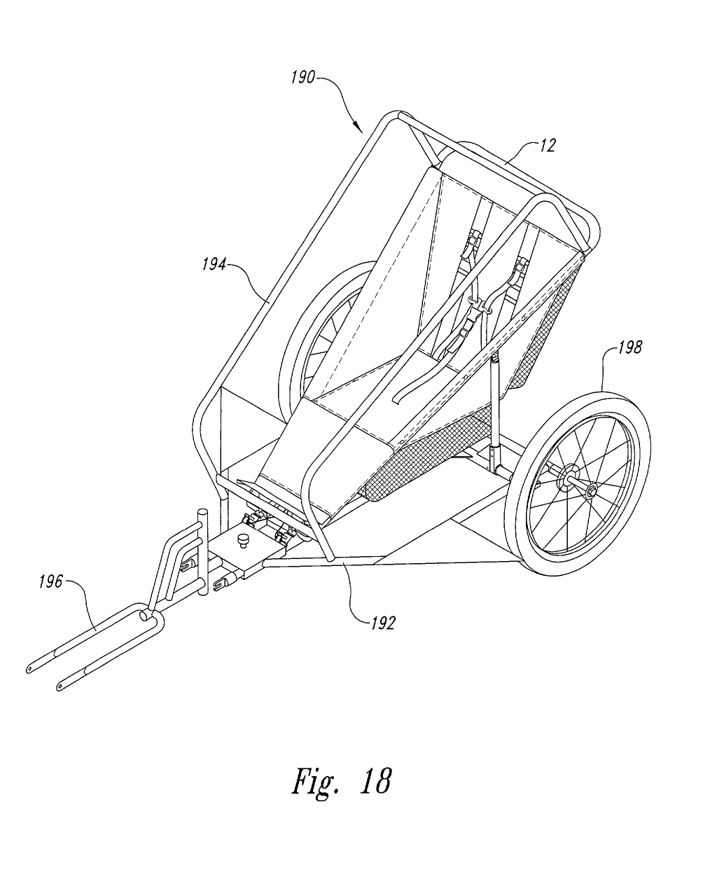

An alternative embodiment of the trailer 190 is shown in FIGS. 17, 17A, 17B, and 18. In this embodiment, there is a bottom frame member 192, a front frame member 194, a tongue 196, and wheels 198. The bottom frame member 192 has left and right diverging frame tubes 200 that are spaced apart and diverge as they extend rearward from the front of the trailer. A triangular plate 202 is attached to each of the diverging frame tubes 200 at rearward end portions thereof, disposed in the same plane as that defined by the diverging frame tubes 200. There are also left and right rear frame tubes 204 that are fixedly connected at forward ends thereof to rearward portions of the corresponding diverging frame tubes 200. The frame tubes 204 are disposed in parallel space apart relation to one another in the same plane as the diverging frame tubes 200.

A rear axle 206 extends laterally and transversely across a rearward end of the parallel rear frame tubes 204. The rear axle 206 has end portions that bend and slope upward such that the left and right wheels 198 of the stroller are tilted with the bottom portions of the wheels disposed laterally outward of the top portions.

The forward ends of the diverging frame tubes 200 are fixedly attached to the sidewalls 210 of a bottom retaining plate 208, shown in FIGS. 17 and 17B, at the forward end portion of the trailer. The parallel side walls 210 that extend upward and from the bottom retaining plate 208, with the sidewalls 210 aligned in longitudinal and vertical planes and the bottom plate 208 aligned in a horizontal plane. The side walls 210 are spaced apart a distance sufficient to place the forward end portions of the base frame tubes 22 of a typical stroller between the sideswalls 210, so that they may rest against the bottom retaining plate 208, with the outside portions of the base frame tubes 22 fitting snuggly against the side walls 210. There is also a top retaining plate 212, which is configured to be mounted over the bottom plate 208 so that the top edges of the sidewalls 210 fit against the top plate 212 and enclose and capture the base frame tubes 22 of the stroller between the retaining plates and sidewalls. A bolt with a knob 214 is threaded through apertures on both plates to hold the plates together.

At a rearward end portions of the rear frame tubes 204, there are retaining pin assemblies 216, shown in FIGS. 17 and 17A. There are left and right laterally aligned cylindrical sleeves 218 with interior cylindrical chambers open at both ends of the sleeves. The sleeves 218 are fixedly and transversely attached to a rearward end portion of the rear frame tubes 204. The sleeves 218 are positioned such that the tubular outer end portions 8 of the rear axle assembly 6 of the stroller frame 14 can be positioned between the left and right sleeves 218 with the outer end portions 8 axially aligned with the sleeves 218, with the left and right outer end portions adjacent the inward ends of the sleeves 218. There are left and right retaining pins 220 that can be inserted through the interior chambers of the sleeves. The retaining pins 220 are sufficiently long to extend from the outwardly facing openings on the sleeves, through to the tubular outer end portions 8 of the rear axle assembly 6 of the stroller, such that inward end portions of the pins 220 can be inserted coaxially within the tubular outer end portions 8, thereby securing the rear axle assembly 6 of the stroller to the trailer 190. Knobs 226 on outward end of the pins help with withdrawal and insertion of the pins.

The inward end portions the retaining pins 220 and the tubular outer end portions 8 of the rear axle assembly 6 of the stroller 12 are configured to mate together in substantially the same manner as do the stub axles with the rear axles of the stroller frame disclosed in U.S. Pat. No. 5,476,275, and discussed earlier for the removable wheels 27 of the trailer 28. Like the stub axles of the wheels, the inward end portions of the retaining pins 220 have a circumferential bevel 222 and a circumferential groove 224 as shown in FIG. 17A. There is a movable pin on the rear axle assembly 6 of the stroller that extends through an aperture in the axle assembly, into an interior chamber of the axle assembly. When the retaining pins 220 are inserted into the outer end portions 8 of the rear axle assembly 6 of the stroller, an inner portion of the movable pin projects into the groove 224 of the retaining pin 220 to prevent withdrawal of the retaining pin 220. As described earlier for the removable wheels 27 of the trailer, the typical stroller also has a strip spring which is configures such that when a slight manual force is applied against the restoring force of the strip spring, the movable pin is withdrawn, allowing the retaining pin 220 to be withdrawn from the rear axle of the stroller.

As shown in FIG. 17, the front fame member 194 of the alternative embodiment comprises left and right front frame tubes 195. The front frame tubes 195 are spaced apart in relation to one another with slightly converging configuration. When a stroller frame 14 is placed within the trailer and the front fame tubes are positioned for operation, they extend back from the forward end portion of the trailer 190, proximate the bottom retaining plate 208, to a rearward end portion of the upper frame tubes 24 of the stroller frame 14. The front fame tubes 195 are also downwardly sloping like the upper frame tubes 24 of a typical baby stroller used with the trailer 190. In addition, the forward end portions and rearward end portions of the front frame tubes are bent downward toward the stroller. The forward end portions of the left and right front frame tubes 195 are each releasably connected to a forward end portion of the corresponding left and right diverging frame tubes 200, while the rearward end portions of the front frame tubes 195 are releasably connected to a rearward end portion of the upper frame tubes 22 of the stroller.

A lower tubular cross bar 228 extends laterally across the front frame tubes 195, proximate the top retaining plate 212. There is also a top tubular cross bar 230 that extends laterally across the front frame tubes 195, at the bends in the front frame tubes at the rearward end portions thereof.

Some stroller embodiments used with the trailer 190 have upper frame tubes 20 which are releasable from the base frame tubes 22 at forward end portions thereof. In these embodiments, the stroller may also have upright frame tubes 25 that are pivotally connected to both the upper frame tubes 20 and base frame tubes 22. In such stroller embodiments, the upper frame tubes 20 can be folded down and aligned with the base frame tubes 22 when the forward ends of the upper and base frame tubes are released from one another. In the aforementioned alternative embodiment of the trailer, the front frame tubes 195 of the trailer 190 may be released from the trailer 190 so that the stroller can be folded with the trailer 190 as a unit without removing the stroller frame 14 from the trailer.

In the first described embodiment, the axle latch assemblies 52 and front latch assemblies 116 are employed to retain the stroller 12 in the trailer 28. The retaining pin assembly 216 and retaining plates 208 and 212, with sidewalls 210, may also be employed interchangeably with the latch assemblies. It is also noted that the designs of the trailer 28 and 190 are adaptable to a variety of stroller types by various manufacturers.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. A bicycle trailer for a baby stroller frame with a seat comprising:
a left wheel and a right wheel;
a trailer frame to which the left wheel and right wheel are connected, having a plurality of trailer frame members and being configured to permit an unmodified baby stroller frame with a seat to be inserted and secured in the trailer frame without the trailer frame members being moved; and
a towing arm connected to the trailer frame.

2. The bicycle trailer of claim 1 wherein a plurality of the trailer frame members rise upwardly from the base of the trailer frame, disposed about a perimeter of the stroller, proximate the perimeter of the stroller.

3. The bicycle trailer of claim 1 further comprising at least one latch assembly connected to the base of the trailer frame and configured to permit selective locking of the baby stroller frame to trailer frame when the baby stroller frame is inserted in the trailer frame.

4. The bicycle trailer of claim 3 further comprising an actuating knob capable of use for operating the at least one latch assembly to release or lock the stroller frame to the trailer frame.

5. The bicycle trailer of claim 1 wherein the trailer has at least two wheels and the trailer frame has an axle with a downward bend in its center to which the wheels are attached.

6. The bicycle trailer of claim 5 wherein the at least two wheels are tilted.

7. The bicycle trailer of claim 1 further comprising at least two pivotally connected frame members.

8. The bicycle trailer of claim 7 wherein the trailer frame is foldable.

9. The bicycle trailer of claim 1 wherein the towing arm can be releasably connected to one of the plurality of frame members that rises upwardly above the height of the stroller frame.

10. A bicycle trailer for a baby stroller frame with a seat comprising:
at least one left wheel and at least one right wheel;
a trailer frame to which the wheels are rotatably mounted, having at least one locking mechanism that can be used for selectively locking and securing a baby stroller frame within the trailer frame, the trailer frame also comprising a plurality of upward and laterally extending frame members that form a protective roll cage about a stroller frame secured within the trailer frame, the trailer frame being configured so that a stroller can be inserted and secured within the trailer frame without modification to the stroller frame; and
a tongue connected to the trailer frame for towing the trailer frame.

11. The bicycle trailer of claim 10 wherein the upwardly extending frame members include at least one front frame member and at least one rear frame member, each of which are pivotally connected to a bottom frame member at lower end portions thereof and releasably attached to one another at upper end portions thereof.

12. The bicycle trailer of claim 11 wherein there are a plurality of rear frame members and at least one of the rear frame members is a support member having an upper end portion releasably attached to another of the rear frame members, and a lower end portion pivotally connected to the bottom frame member.

13. The bicycle trailer of claim 12 wherein the upper end portions of the rear frame members and front frame members can be release from one another and the members can be pivoted downward about the pivoting connections thereof so that the members come to rest in folded positions, substantially aligned with a longitudinal axis of the bottom frame member.

14. The bicycle trailer of claim 10 wherein there is at least one latch assembly on the trailer frame that can be remotely locked and released to selectively secure and release the stroller frame within the trailer frame.

15. The bicycle trailer of claim 14 further comprising a remote lever used to selectively lock and release the latch assembly.

16. The bicycle trailer of claim 15 wherein the remote lever is located on a rear frame member of the trailer frame at a height convenient for a user of the trailer.

17. The bicycle trailer of claim 14 wherein the at least one latch assembly has a biasing member that biases the latch assembly in a locked position.

18. The bicycle trailer of claim 17 wherein there is a remote lever and a cable extending from the knob to the at least one latch assembly and the lever is configured such that it can be used to selectively pull and release the cable, wherein when the cable is pulled the latch is unlocked and when the cable is released a restoring force of the biasing member locks the latch assembly.

19. The bicycle trailer of claim 10 wherein there are at least two wheels and the wheels are rotatably mounted to the bottom frame in tilted orientation so that a bottom portion of the wheels are disposed laterally outward of a top portion of the wheels.

20. The bicycle trailer of claim 10 wherein the at least one locking mechanism that secures the stroller frame to the trailer frame locks a base of the stroller to a bottom frame of the trailer.

21. The bicycle trailer of claim 20 wherein the trailer frame is absent locking mechanisms affixed to any location on the trailer frame for securing the stroller to the trailer except on the bottom frame of the trailer and the at least one locking mechanism is configured to lock to the base of the stroller without contacting any other portion of the stroller.

22. A bicycle trailer for a baby stroller frame with a seat comprising:
a left wheel and a right wheel;
a trailer frame having a plurality of frame members including an axle to which the left and right wheel are rotatably mounted, wherein the base of a stroller frame can be secured to an at least one bottom frame member of the trailer frame within the trailer frame, the base of the stroller frame being the only point of contact between the stroller frame and the trailer frame; and
a tongue for connecting the trailer frame to a bicycle.

23. The bicycle trailer of claim 22 wherein the stroller frame is secured to the bottom frame member by latch assemblies that can be remotely controlled to lock or release the stroller frame from the bottom frame member of the trailer.

24. The bicycle trailer of claim 22 wherein the stroller frame can be inserted into and secured in the trailer frame without repositioning any of the trailer frame members.

25. A bicycle trailer for a baby stroller frame with a seat comprising:
a left wheel and a right wheel;
a trailer frame to which the left wheel and right wheel are connected, having a plurality of trailer frame members with some of the frame members forming a protective roll cage for a stroller frame inserted within the trailer frame, the trailer frame members being configured to permit an unmodified baby stroller frame with a seat to be inserted and secured in the trailer frame without the trailer frame members being moved; and
a towing arm configured tow the trailer frame by being connected at one end portion thereof to trailer frame members that form part of the protective roll cage of the of the trailer frame and at another end portion to the bicycle.

26. The bicycle trailer frame of claim 25 further comprising at least one latch assembly fixedly attached to an end portion of the tongue, the latch assembly being configured to engage and lock to the trailer frame.

27. The bicycle trailer frame of claim 25 further comprising a hitch assembly attached to an end portion of the tongue, the hitch assembly having a forward portion and a rearward portion pivotally and releasably connected to each other, with the rearward portion flexibly attached to the tongue and the forward portion configured to be releasably attached to a bicycle.

28. The bicycle trailer frame of claim 27 wherein the forward portion and rearward portion of the hitch assembly are pivotally connected by a removable pin.

29. The bicycle trailer frame of claim 27 wherein the rearward portion of the hitch assembly is flexibly connected to the tongue by an elastic strip that is disposed coaxially within the tongue at a forward end portion of the tongue.

30. A trailer for a baby stroller frame with a seat comprising:
a left wheel and a right wheel;
a trailer frame having a bottom frame, front frame, and rear frame, with the left and right wheel rotatably mounted to the bottom frame, and with the bottom frame, front frame, and rear frame each having a plurality of frame members that form a protective roll cage for a stroller frame mounted in the trailer frame, whereas an unmodified stroller frame can be inserted into the trailer frame between the plurality of rear frame members, and there is at least one locking mechanism for selectively and securely locking the unmodified stroller frame to the trailer frame; and
a tow arm for towing trailer frame.

31. The bicycle trailer of claim 30 wherein the at least one locking mechanism is attached to the bottom frame of the trailer frame such that it can be used to selectively lock a base of the stroller frame to the bottom frame.

32. The bicycle trailer of claim 30 wherein the locking mechanism can be remotely operated to selectively secure or release the stroller frame from the bottom frame of the trailer.

33. The bicycle trailer of claim 31 wherein there is a remote lever located on the rear frame, near the top of the rear frame, that can be used to actuate the locking mechanism to selectively secure or release the stroller frame from the bottom frame of the trailer.

34. The bicycle trailer of claim 30 wherein the front frame and rear frame are each pivotally connected to the bottom frame and can be folded down toward the bottom frame so that a longitudinal axis for each member is substantially aligned with a longitudinal axis of the bottom frame member.

35. The bicycle trailer of claim 30 wherein the left and right wheel are tilted with a bottom end portion of each wheel being disposed laterally outward of a top end portion the corresponding wheel.

36. The bicycle trailer of claim 35 wherein the bottom frame of the trailer comprises a axle to which the left and right wheel are rotatably mounted on opposite ends thereof, the axle having a downward bend near the center of the axle such that the end portions of the axle slow downward and inward toward the bend.

37. The bicycle trailer of claim 30 wherein a front wheel can be rotatably attached to the stroller frame while it is inserted and secured within the trailer frame, the front wheel being configured to enable a user to push the stroller frame without releasing it from the trailer frame.

38. A bicycle trailer for a baby stroller frame with a seat comprising:
a left wheel and a right wheel,
a trailer frame in which a baby stroller frame can be inserted and secured,
a cylindrical tongue for towing the trailer frame, having an interior cylindrical chamber,
a cylindrical elastic strip inserted longitudinally within the chamber of the tongue through an opening at a forward end of the tongue and fixedly attached to a wall of the interior chamber of the tongue,
a solid cylindrical sleeve aligned coaxially with the tongue disposed proximate a forward end portion of the tongue, the cylindrical sleeve being sized to fit coaxially within the tongue with a portion of the sleeve thus disposed and at least a portion of sleeve extending beyond the tongue and fixedly attached to a forward end portion of the elastic strip; and
a hitch assembly fixedly attached to the cylindrical sleeve.

39. The bicycle trailer of claim 38 wherein the hitch assembly comprises a forward portion pivotally connected to a rearward portion, with the rearward portion connected to the cylindrical sleeve.

40. The bicycle trailer of claim 39 wherein the pivoting connection is a releasable connection comprising a removable pin inserted between connecting members on the rearward and forward portions of the hitch assembly.

41. A bicycle trailer for a baby stroller frame with a seat comprising:
a left wheel and a right wheel,
a trailer frame comprising:
left and right bottom frame tubes having laterally extending frontal section tubes with latch assemblies connected to the frontal sections for selectively locking forward end portions of parallel base frame tubes of a stroller to the trailer frame, the latch assemblies each comprising two adjacent retainer pieces with a latch pivotally disposed between them,
a tubular rear axle extending laterally across the bottom frame tubes with a downward bend midway between the end of the axle such that the end portions of the axle slope inwardly downward, and are fixedly connected to the left and right bottom frame tubes, with the left and right wheels being rotatably and removably mounted on the left and right end portions of the tubular rear axle in tilted configuration such that bottoms portions of each wheel are disposed laterally outward of the corresponding top portions,
a latch support tube extending laterally across the bottom frame tubes to which two latch assemblies are connected for locking a rear axle of the stroller frame to the trailer frame,
a tubular cross bar extending laterally across the bottom frame tubes,
left and right parallel front frame tubes pivotally connected to corresponding left and right frontal section tubes at the bottom ends thereof, the front frame tubes each extending upward the frontal sections of the bottom frame tubes and curving rearward,
a tubular hitch bar extending between the left and right parallel front frame tubes,
left and right upright rear frame tubes pivotally connected to the left and right bottom frame tubes at lower ends thereof,
left and right support tubes each pivotally connected to the left and right bottom frame tubes at one end and releasably connected to the left and right upright rear frame tubes at another,
a horizontal frame tube with left and right ends integral to the upperend portions of the left and right upright rear frame tubes; and
releasable connections between the tops of the parallel front frame tubes and the horizontal frame tube and between the support tubes upright rear frame tubes, whereby when the releasable connections are released, the front frame tubes and upright rear frame tubes can be folded downward by pivoting about the pivoting connections thereof.
a towing arm for connecting the trailer frame to a bicycle.

42. The bicycle trailer frame of claim 41 wherein the frame is configured such that a user can insert and secure an unmodified baby stroller frame with a seat into the trailer frame without having to move any of the trailer frame tubes.

43. The bicycle trailer of claim 41 wherein the towing arm comprises:
a cylindrical tongue for towing the trailer frame, having an interior cylindrical chamber,
a cylindrical elastic strip inserted longitudinally within the chamber of the tongue through an opening at a forward end of the tongue and fixedly attached to a wall of the interior chamber of the tongue,
a solid cylindrical sleeve aligned coaxially with the tongue disposed proximate a forward end portion of the tongue, the cylindrical sleeve being sized to fit coaxially within the tongue with at least a portion of sleeve extending beyond the tongue and fixedly attached to a forward end portion of the elastic strip; and
a hitch assembly with a rearward arm and forward arm pivotally connected to one another by a removable pin, with the rearward arm fixedly attached to the cylindrical sleeve and with a hitch, configured to be removably and securely connected to a bicycle seat bar, fixedly attached to the forward arm.
